(19) United States
(12) Patent Application Publication
(10) Pub. No.: US 2025/0391096 A1
(43) Pub. Date: Dec. 25, 2025

(54) RAY TRACING STACK NODE TRAVERSAL REDUCTION

(71) Applicant: ADVANCED MICRO DEVICES, INC., Santa Clara, CA (US)

(72) Inventors: John Tsakok, Folsom, CA (US); David Kirk McAllister, Holladay, UT (US)

(21) Appl. No.: 18/751,901

(22) Filed: Jun. 24, 2024

(51) Int. Cl. G06T 15/06; G06T 15/00

(52) U.S. Cl. CPC G06T 15/06; G06T 15/005; G06T 2210/21

(57) ABSTRACT

A processing circuit is configured to generate frames based on ray tracing context data stored by a bounding volume hierarchy (BVH) structure. Generating the stream of frames includes traversing the BVH structure, which includes a plurality of nodes. As part of traversing the BVH structure, in response to detecting that a ray intersects with a first bounding volume (BV) or primitive corresponding to a first node of the BVH structure, a discard value is checked, where the discard value is generated based on overlaps between the first BV or primitive and at least one BV or primitive corresponding to at least one sibling node of the BVH structure. In response to the discard value indicating that the sibling node is to be discarded, traversal of the sibling node is omitted. In response to the discard value indicating that the sibling node is to be traversed, the sibling node is traversed.

### BACKGROUND

To improve the fidelity and quality of generated images, some software, and associated hardware, implement ray tracing operations that generate images or frames by tracing paths of light of rays associated with the image. Some of these ray tracing operations employ a tree structure, such as a bounding volume hierarchy (BVH) tree, to represent a set of geometric objects within a scene to be rendered. The geometric objects (e.g., triangles, circles, or rectangles) are enclosed in primitives that correspond to leaf nodes of the tree structure. These leaf nodes are grouped into sets of siblings, with each set connected to a respective parent internal node. The internal nodes correspond to bounding volumes (BVs) that encompass the primitives corresponding to the leaf nodes of their children nodes. The sets of internal nodes then are bound into larger sets that are similarly connected to a higher internal node in the tree structure, and so forth, until there is a single node at the top node of the tree structure and which corresponds to a BV that encompasses all lower-level BVs and primitives.

To perform some ray tracing operations, the tree structure is traversed to identify potential intersections between generated rays and the geometric objects in the scene. At each node being traversed, a ray of interest is compared with the BV or primitive of that node to determine if there is an intersection. If an intersection is identified and the node is an internal node, the algorithm continues on to a child node in the tree. If no intersection is identified or a leaf node is considered, the algorithm continues to an unconsidered sibling node if available or a sibling of a parent node if not. The algorithm continues to consider nodes until the entire tree is traversed. However, conventional approaches to traversing the tree structure sometimes consume a relatively high amount of system resources, consume a relatively large amount of time, or both. In some cases, conventional approaches use even more resources, time, or both when the tree structure uses more nodes. As a result, in some cases, overall quality of the resulting images is limited due to a quantity of system resources, an amount of available time, or both.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing circuit that manages ray tracing in accordance with some implementations.

FIG. 2 is a block diagram of a processing system that includes a ray tracing stack node traversal reduction circuit in accordance with some implementations.

FIG. 3 is a block diagram of an example bounding volume hierarchy structure of a ray tracing operation in accordance with some implementations.

FIG. 4 is a block diagram of an example set of bounding volumes corresponding to nodes that are traversed as part of a ray tracing operation and a corresponding stack structure in accordance with some implementations.

FIG. 5 is a block diagram of an example set of bounding volumes corresponding to nodes that are traversed as part of a ray tracing operation and a corresponding stack structure in accordance with some implementations.

FIG. 6 is a flow diagram of a first method of managing stack node traversal of a bounding volume hierarchy structure in accordance with some implementations.

FIG. 7 is a flow diagram of a second method of managing stack node traversal of a bounding volume hierarchy structure in accordance with some implementations.

### DETAILED DESCRIPTION

When performing some approaches to ray tracing operations, a bounding volume hierarchy (BVH) structure (e.g., a BVH tree) is formed of nodes storing data corresponding to bounding volumes (BVs) or primitives. In some implementations, the nodes store coordinates or other data indicating the boundaries of the respective BVs or primitives. In other implementations, the nodes store pointers to coordinates or other data indicating the boundaries of the respective BVs or primitives. In some cases, it is desirable to identify a primitive that is a “closest hit” to an origin of a ray, such as situations where the closest hit would obscure other primitives. To identify a closest hit, the BVH structure is traversed and stack entries (e.g., node pointers) corresponding to BVs and primitives are added to a BVH stack for potential processing. In some cases, several BVs are identified as being hit or otherwise intersected by the ray. A node corresponding to a closest BV to the origin of the ray is selected for traversal, with a stack entry (e.g., a node pointer) being added to the BVH stack as part of the traversal process. Stack entries corresponding to remaining primitives and BVs are added to the BVH stack for checking in the future.

In some cases, full traversal of every node in the BVH structure consumes a relatively high amount of system resources, consumes a relatively large amount of time, or both, especially with wider (e.g., four nodes per level or sixty-four nodes per level) BVH structures. For example, computation resources are generally more strained when up to eight nodes are potentially pushed onto a BVH stack that includes information regarding nodes to check for collision with a ray rather than up to two nodes. However, wider BVH trees allow for tighter bounds of space containing potential primitives, BVH trees with fewer levels, or both.

In some implementations, traversal of nodes corresponding to primitives which are farther away from an origin than other primitives can be omitted. For example, in some cases, a first primitive which intersects with a ray is farther away from an origin of the ray than a second primitive which also intersects with the ray. In those cases, processing the first primitive can be omitted because the ray would find its closest hit before reaching the first primitive. Similarly, internal nodes corresponding to BVs which encompass primitives that either do not intersect with the ray or are farther away from the origin than other primitives that intersect with the ray can also be omitted. As a result, in some cases, a number of nodes considered is reduced and computation resources are less strained.

In some cases, determining whether processing of a given BV or primitive is to be omitted is difficult because it is performed based on factors of the BV or primitive relative to the other BVs or primitives. For example, in some cases, there is an overlap between two BVs or two primitives such that a first detected hit is not actually a closest hit to an origin of a ray. One way to determine whether processing of a given BV or primitive can be omitted is to save a hit distance along the path of the ray for each BV or primitive in each corresponding BVH stack entry and compare those hit distances, omitting processing of BVs or primitives having further hit distances. However, an amount of memory used to store the BVH stack entries including the hit distances is undesirably large. For example, in some cases, an amount of memory used to store the BVH stack entries including the hit distances is 150%, 200%, or even larger, as compared to an amount of memory used to store the BVH stack entries without the respective hit distances.

Using the techniques described herein, stack entries corresponding to BVs or primitives which intersect with a ray are omitted from processing based on whether those BVs or primitives overlap with other BVs or primitives that intersect with the ray, where those BVs or primitives overlap with other BVs or primitives that intersect with the ray, or both. In some implementations, overlap data is determined prior to traversing the BVH structure (e.g., before the path of the ray is known). For example, in some cases, the overlap data is determined during a build time of the BVH structure. A discard value is generated for a node of the BVH structure that indicates whether a corresponding BV or primitive overlaps with one or more other BV or primitives (e.g., BVs corresponding to internal sibling nodes in the BVH structure). In various implementations, the discard value is small relative to a size of BVH stack entries (e.g., one bit or eight bits per child node of the BVH structure). During ray tracing operations, if a BV or primitive is identified as a potential first collision with the ray, the discard value indicates that traversal of nodes corresponding to sibling BVs or primitives that do not overlap with the BV or primitive is to be omitted. In some cases, stack entries corresponding to nodes that are to be omitted are culled from or popped off the BVH stack. In other implementations, overlap data is determined as part of traversing the BVH structure (e.g., after the path of the ray is known using ray/box intersection ranges). A discard value is generated for a BV or primitive that indicates whether the BV or primitive overlaps with one or more other BVs or primitives (e.g., BVs or primitives corresponding to each sibling node in the BVH structure) along a path of the ray. In some cases, determining discard values during traversal of the BVH structure reduces a number of entries traversed or otherwise processed in the BVH stack more, as compared to determining discard values prior to traversing the BVH structure. However, in some cases, determining discard values prior to traversing the BVH structure uses fewer computing resources (e.g., arithmetic logic units (ALUs) at a time when processing resources are more in demand (e.g., due to traversing the BVH structure). Accordingly, in some implementations, a number of entries of the BVH stack upon which intersection tests are performed is reduced, reducing consumption of system resources as compared to ray tracing operations that do not use discard values.

As used herein, traversal of a node is considered “omitted” if, rather than performing an intersection test for a corresponding BV or primitive, the node is considered not to be a closest hit based on a discard value.

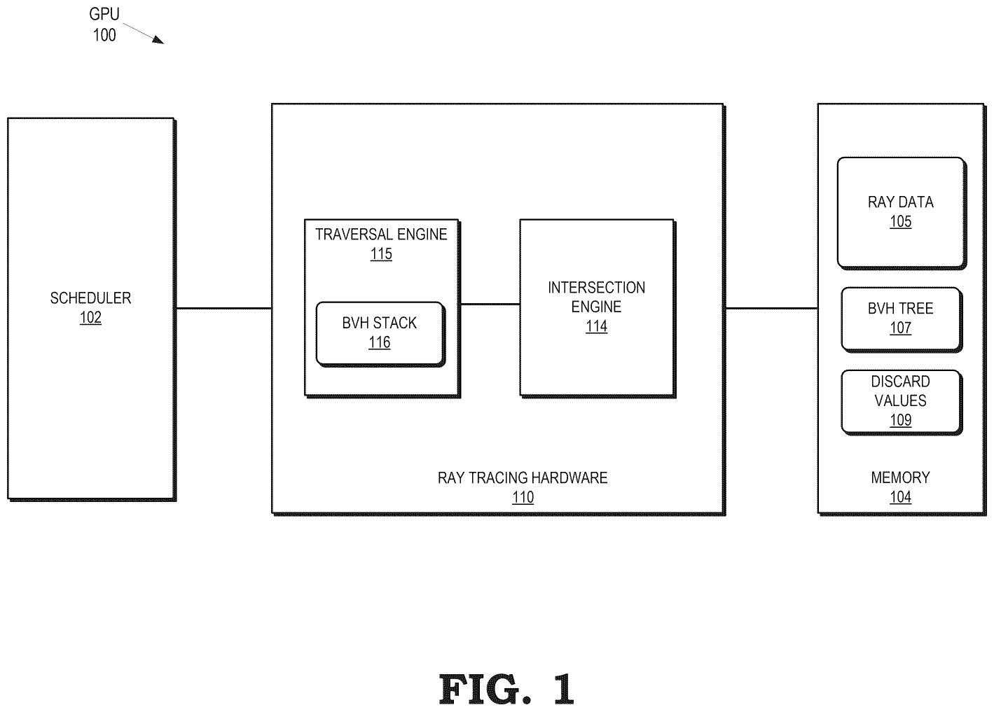

For purposes of description, FIGS. 1-7 are described with respect to examples where ray tracing operations are implemented at a graphics processing unit (GPU) that performs a traversal process to traverse a BVH tree. However, it will be appreciated that, in other implementations, the techniques described herein are implemented at different types of processing circuits, are implemented to traverse a different type of acceleration structure, or any combination thereof. For example, in various implementations, the techniques described herein are implemented at one or more vector processors, coprocessors, GPUs, general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), application specific integrated circuits, or any combination thereof.

FIG. 1 illustrates a block diagram of a GPU 100 that performs ray tracing and other graphical operations on behalf of a processing system in accordance with some implementations. The processing system is generally configured to execute sets of instructions (e.g., computer programs) to perform specified tasks on behalf of an electronic device. Accordingly, in different implementations, GPU 100 is incorporated into any one of a number of electronic devices, such as a desktop computer, laptop computer, server, smartphone, tablet, game console, and the like.

GPU 100 receives commands (e.g., draw commands) from another processing unit (not shown) of the processing system, generates one or more GPU commands based on the received commands, and to execute the generated GPU commands by performing one or more graphical operations. At least some of those GPU commands include texture operations, such as ray tracing operations. To facilitate execution of the texture operations, the GPU 100 includes a scheduler 102, a memory circuit 104, and ray tracing (RT) hardware 110.

Scheduler 102 schedules or sequences commands for execution at various circuits of GPU 100, including RT hardware 110. In at least some implementations, scheduler 102 receives the commands for scheduling from one or more of these same circuits, or from another circuit of GPU 100, such as from a command processor (not shown).

Memory circuit 104 stores data used for various operations at GPU 100, including ray tracing and other texture operations. In various implementations, memory circuit 104 is memory embedded within GPU 100, is external to GPU 100, or any combination thereof. In the depicted implementation, memory circuit 104 stores ray data 105, representing the data associated with the rays used for the ray tracing operations described herein. For example, in some implementations, ray data 105 stores, for each ray for which ray tracing is to be performed, a ray identifier (referred to as a ray ID) (in at least some implementations, the ray ID is not separately stored, but is indicated by the index for the entry or line where the ray data is stored), vector information indicating the origin of the ray in a coordinate frame and the direction of the ray in the coordinate frame, and other data used to perform ray tracing operations.

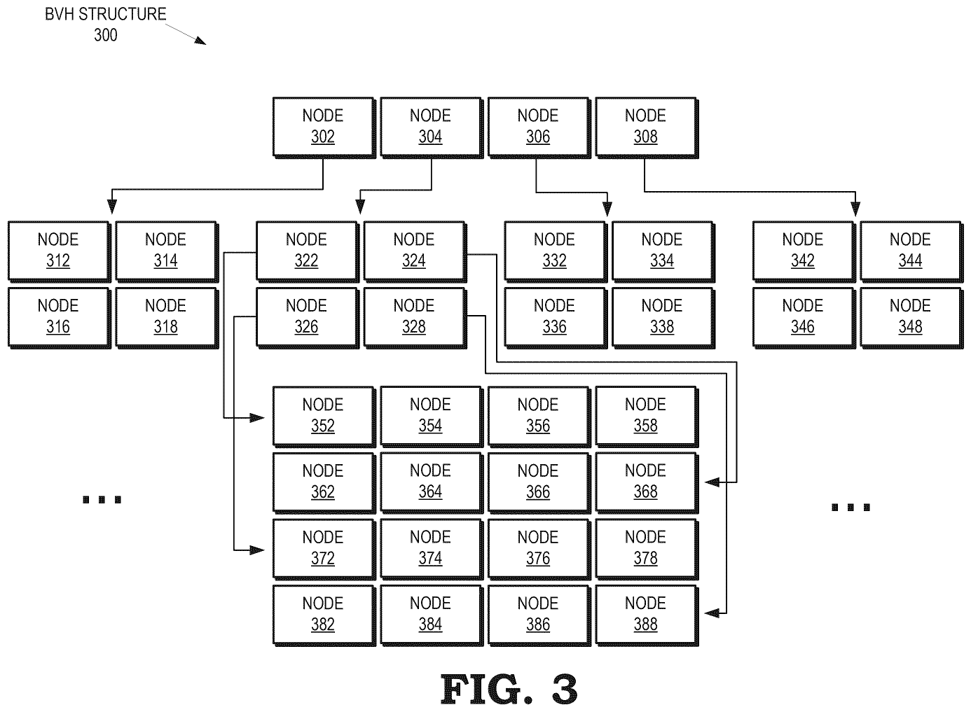

Memory circuit 104 also stores a BVH structure, BVH tree 107, that is employed by GPU 100 to implement ray tracing operations. As further discussed with reference to FIG. 3, BVH tree 107 includes a plurality of nodes organized as a tree, with primitives covering areas including objects of a scene to be rendered, where the primitives correspond to leaf nodes of the tree structure. The leaf nodes are grouped into a level of smaller sets, with each set enclosed in their own parent node of the tree structure. Each parent node corresponds to a BV that encompasses the BVs or primitives of children nodes. Nodes that share a same immediate parent node are considered sibling nodes herein. The smaller sets then are bound into another level of larger sets that are likewise enclosed in their own higher parent node on the tree structure, and so forth, until there is a level including a single node of BVH tree 107 and which encompasses all lower-level nodes. In some implementations, nodes of BVH tree 107 include respective portions of ray data 105, and thus ray data 105 is not stored separately.

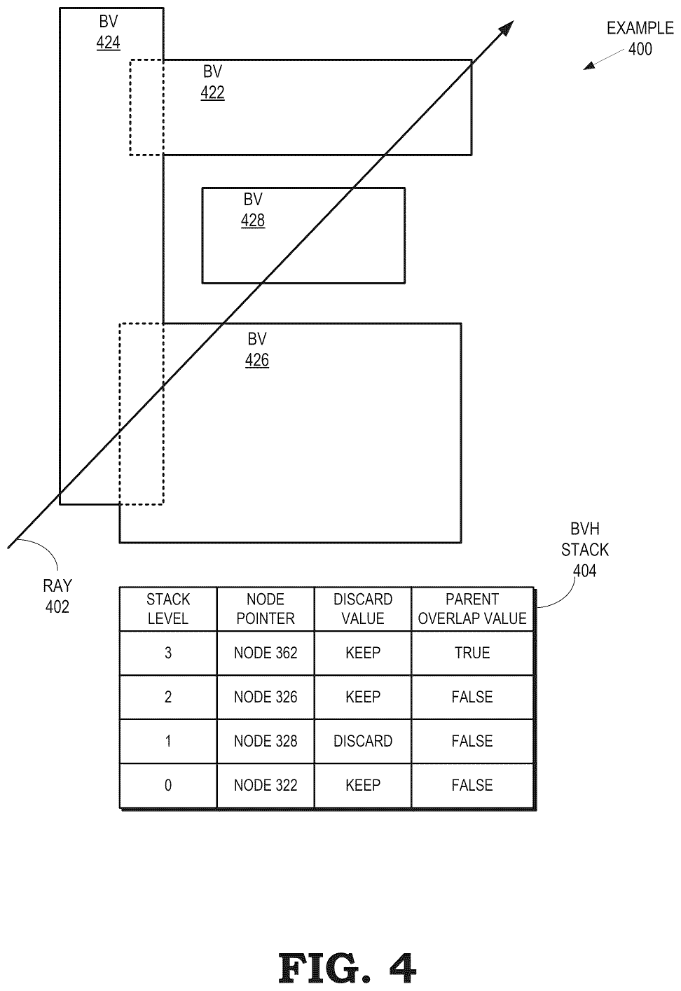

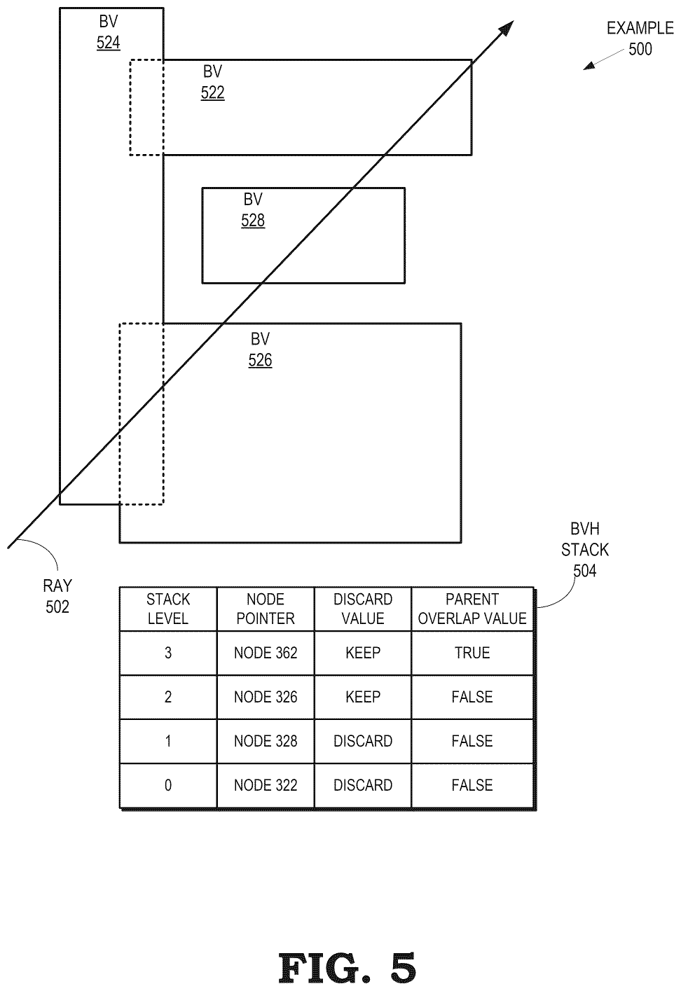

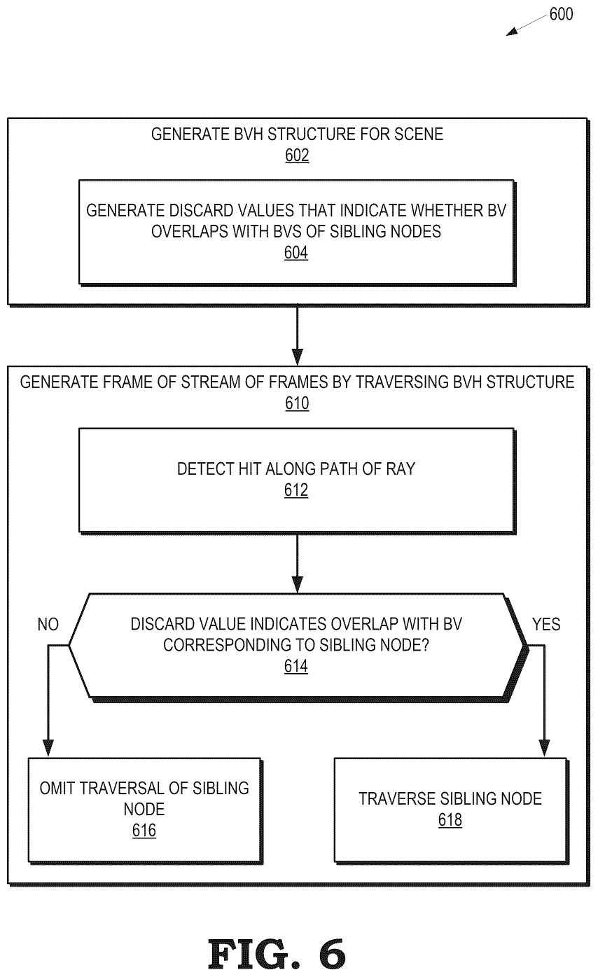

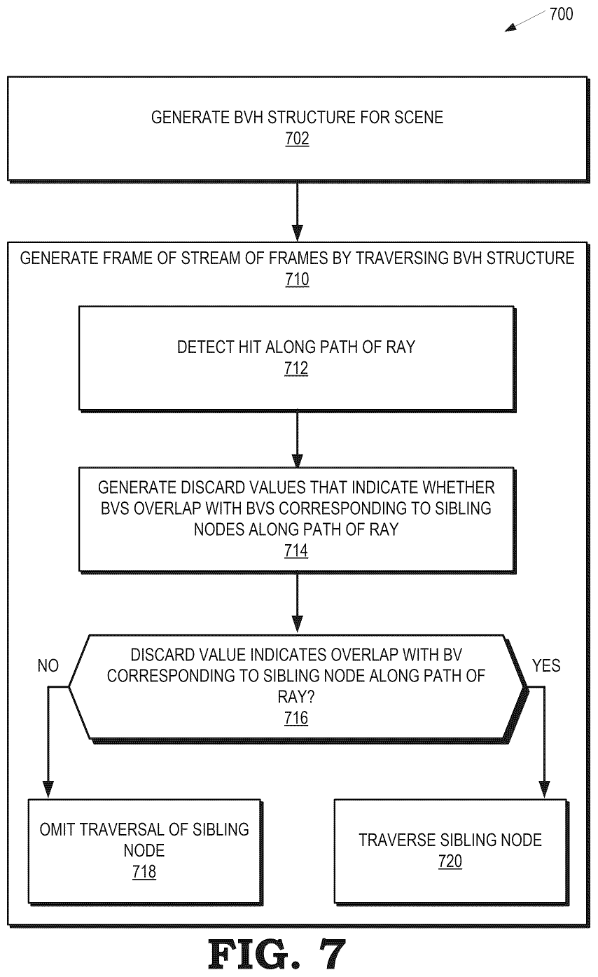

In some implementations, memory circuit 104 stores discard values 109 that are used to identify whether traversal of nodes of BVH tree 107 should be omitted despite detecting an intersection between a ray and a BV or primitive corresponding to the node. The process for determining discard values is further discussed below. In other implementations, discard values 109 are stored elsewhere, such as being part of the entries of BVH stack 116, being stored at another memory circuit of RT hardware 110, or at another memory circuit (e.g., another memory circuit of GPU 100 or a memory circuit external to GPU 100). In some implementations, as further discussed below with reference to FIGS. 4 and 6, discard values 109 are computed prior to traversal of BVH tree 107. In other implementations, as further discussed below with reference to FIGS. 5 and 7, discard values 109 are computed as part of traversal of BVH tree 107.

RT hardware 110 includes one or more circuits that execute ray tracing and other texture operations. In particular, RT hardware 110 performs intersection operations that identify whether a given ray intersects with a given BV or primitive corresponding to a BVH node, and traversal operations that traverse BVH tree 107 based on the intersection operations. To facilitate these operations, the RT 110 includes an intersection engine 114 and a traversal engine (TE) 115. In various implementations, the intersection engine 114 and TE 115 are hardware circuitry designed and configured to perform the corresponding operations described below. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)).

Intersection engine 114 receives ray data of a ray to be used for ray tracing. Intersection engine 114 iteratively executes a node intersection operation (e.g., an intersection test) to identify whether the ray intersects with a BV or primitive corresponding to a node (referred to as an intersection hit) or does not intersect with the BV or primitive corresponding to the node (referred to as an intersection miss). Intersection engine 114 provides the intersection miss and intersection hit data, along with ray data and BVH node data, to TE 115. In at least some implementations, the intersection engine 114 performs multiple intersection operations in parallel, including intersection operations for different rays. Thus, for example, in some implementations, intersection engine 114 concurrently performs an intersection operation for Ray A (determining whether Ray A intersects with a BV or a primitive corresponding to a node of BVH tree 107) and an intersection operation for Ray B (determining whether Ray B intersects with the same BV or primitive or a different BV or primitive corresponding to one or more nodes of BVH tree 107).

TE 115 performs tree traversal operations based on data stored at BVH stack 116. In particular, TE 115 receives the intersection information (hit data, miss data, ray data, and BVH node data) from intersection engine 114 and stores entries corresponding to nodes to be traversed in BVH stack 116. For example, in some implementations, tree nodes are visited in depth-first order and, for every intersected interior node, the intersected child nodes are sorted based on their distance to ray origin. The furthest nodes are pushed onto BVH stack 116, and the closest node is used as the next intersect for the next iteration of the traversal loop. In some implementations, according to the traversal process, the TE 115 identifies one of three possible outcomes: 1) a next node of BVH tree 107 to be tested for intersection with a ray; 2) a shader to be executed (e.g., an any-hit shader); or 3) an end of the tree traversal process for the current ray. For purposes of description, traversal operations of TE 115 and the intersection operations of intersection engine 114 are collectively referred to as ray tracing operations.

Traversal of wider BVH structures consume a relatively high amount of system resources, consume a relatively large amount of time, or both, as compared to BVH structures including only two nodes per level. In the illustrated implementation, in some cases, traversal of such a structure would put an undesirable number of entries in BVH stack 116. Accordingly, in some cases, it is desirable to perform less processing on some entries of BVH stack 116. In various implementations, GPU 100 omits intersection tests of nodes corresponding to entries of BVH stack 116 using discard values 109 (e.g., by culling those entries from BVH stack 116). These discard values 109 are used in different ways depending on a time at which they are calculated.

In some implementations, one or more discard values 109 are determined prior to performing intersection operations between the ray and the BVs or primitives (e.g., before the path of the ray is known or before collisions are detected). Each discard value corresponds to a respective BV or primitive. In such implementations, generated discard values 109 indicate whether respective BVs or primitives overlap with one or more other BVs or primitives (e.g., with each BV or primitive corresponding to a sibling node in BVH tree 107). During ray tracing operations, if the corresponding BV or primitive is identified as being hit by the ray, the discard value indicates that traversal of sibling nodes that correspond to BVs or primitives that do not overlap with the BV or primitive that is identified as being hit is to be omitted. Additionally, in some cases, a parent discard value is further included, which indicates overlaps of a BV corresponding to a parent node of the respective node and its siblings. In some implementations, discard values 109 are small (e.g., one bit for each sibling node and one bit for the parent discard value) compared to a size of an indicator of a hit distance for a ray. In some cases, because discard values 109 are precomputed, processing of BVH stack 116 is performed more quickly, as compared to implementations where discard values 109 are determined subsequent to performing intersection operations between the ray and the BVs or primitives.

In some implementations, one or more discard values 109 are determined subsequent to performing intersection operations between the ray and the BVs or primitives (e.g., after the path of the ray is known or after collisions are detected). Each discard value corresponds to a respective BV or primitive. In such implementations, generated discard values 109 indicate whether respective BVs or primitives overlap with one or more other BVs or primitives (e.g., with each BV or primitive corresponding to a sibling node in BVH tree 107) along a path of the ray. During ray tracing operations, if the corresponding BV or primitive is identified as being hit by the ray, the discard value indicates that traversal of sibling nodes that correspond to BVs or primitives that do not overlap with the BV or primitive that is identified as being hit along the path of the ray is to be omitted. Additionally, in some cases, a parent discard value is further included, which indicates overlaps of a BV corresponding to a parent node of the respective node and its siblings.

In some implementations, an overlap stack pointer is used as part of a traversal algorithm. This overlap stack pointer is set to equal a current stack pointer, indicating a current node, when a ray hits a BV or primitive. Discard values are only checked when removing stack elements corresponding to nodes below the node indicated by overlap stack pointer within BVH tree 107. If an overlap is found, then the overlap stack pointer is reset to the current stack pointer and traversal continues proceeding down BVH tree 107. In some implementations, discard values 109 are small (e.g., one bit for each sibling node and one bit for the parent discard value) compared to a size of an indicator of a hit distance for a ray. In some cases, because discard values 109 further eliminate overlaps that do not occur along the path of the ray, processing of BVH stack 116 is performed more quickly, as compared to implementations where discard values 109 are determined prior to performing intersection operations between the ray and the primitives.

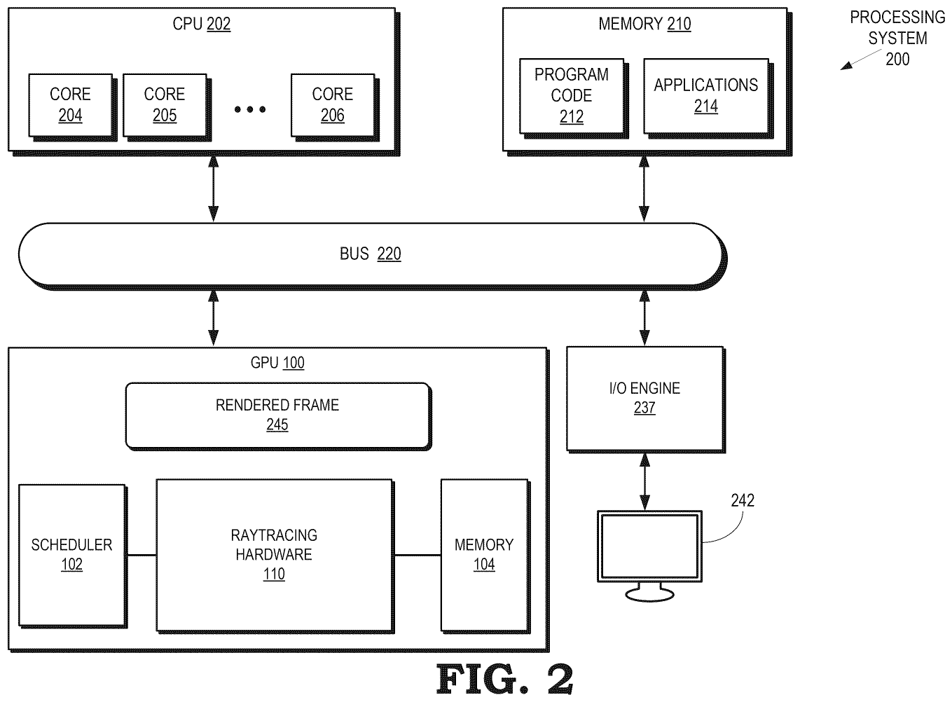

Referring now to FIG. 2, a processing system 200 that performs ray tracing stack node traversal reduction is shown, in accordance with some implementations. Processing system 200 includes or has access to a memory circuit 210 or other storage component implemented using a non-transitory computer-readable medium, for example, a dynamic random-access memory (DRAM). However, in some implementations, memory circuit 210 is implemented using other types of memory including, for example, static random-access memory (SRAM), nonvolatile RAM, and the like. According to some implementations, memory circuit 210 includes an external memory circuit implemented external to the processing units implemented in the processing system 200. Processing system 200 also includes a bus 220 to support communication between entities implemented in the processing system 200, such as memory circuit 210. Some implementations of processing system 200 include other buses, bridges, switches, routers, and the like, which are not shown in FIG. 2 in the interest of clarity.

Processing system 200 includes GPU 100 to implement one or more of the techniques described herein. GPU 100 renders a set of rendered frames each representing respective scenes within a screen space (e.g., the space in which a scene is displayed) according to one or more applications 214 for presentation on a display 242. As an example, the GPU 100 renders graphics objects (e.g., sets of primitives) for a scene to be displayed so as to produce pixel values representing a rendered frame 245. In at least some implementations, the rendered frame 245 is based on ray tracing operations executed at the ray tracing hardware 110. In some cases, a number of stack entries and corresponding nodes, BVs, and primitives considered as part of the ray tracing operations is reduced using discard values as described herein. The GPU 100 then provides the rendered frame 245 (e.g., pixel values) to display 242. These pixel values, for example, include color values (e.g., YUV color values or RGB color values), depth values (e.g., z-values), or both. After receiving the rendered frame 245, display 242 uses the pixel values of the rendered frame 245 to display the scene including the rendered graphics objects. To render the graphics objects, GPU 100 includes processor cores (not shown) that execute instructions concurrently or in parallel. In some implementations, one or more processor cores of the GPU 100 each operate as a compute unit configured to perform one or more operations for one or more instructions received by the GPU 100. These compute units each include one or more single instruction, multiple data (SIMD) units that perform the same operation on different data sets to produce one or more results.

In various implementations, processing system 200 also includes CPU 202 that is connected to the bus 220 and therefore communicates with GPU 100 and memory circuit 210 via bus 220. CPU 202 includes a plurality of processor cores 204 to 206 that execute instructions concurrently or in parallel. Though in the example implementation illustrated in FIG. 2, three processor cores (204, 205, 206) are presented, the number of processor cores implemented in CPU 202 is a matter of design choice. As such, in other implementations, CPU 202 can include any number of processor cores. Processor cores of CPU 202 execute instructions such as program code 212 for one or more applications 214 (e.g., graphics applications, compute applications, machine-learning applications) stored in the memory circuit 210, and CPU 202 stores information in the memory circuit 210 such as the results of the executed instructions. CPU 202 is also able to initiate graphics processing by issuing draw calls to the GPU 100.

In some implementations, processing system 200 includes input/output (I/O) engine 237 that includes circuitry to handle input or output operations associated with display 242, as well as other elements of processing system 200 such as keyboards, mice, printers, external disks, and the like. I/O engine 237 is coupled to bus 220 so that I/O engine 237 communicates with memory circuit 210, GPU 100, and central processing unit (CPU) 202. In some implementations, CPU 202 issues one or more draw calls or other commands to GPU 100. In response to the commands, GPU 100 schedules, via scheduler 102, one or more ray tracing operations at ray tracing hardware 110. For at least one of the ray tracing operations, ray tracing hardware 110 omits traversal of at least one node of a BVH structure using at least one discard value as described above. Based on the ray tracing operations, the GPU 100 generates a rendered frame, and provides the rendered frame to display 242 via I/O engine 237.

FIGS. 3-5 collectively depict several processes of managing stack node traversal of a BVH structure, such as BVH tree 107 of FIG. 1, using discard values such as discard values 109 of FIG. 1. In some implementations, such as the implementation of FIG. 4, a discard value is determined based on whether a BV corresponding to a first node overlaps with BVs corresponding to respective sibling nodes. In other implementations, such as the implementation of FIG. 5, the discard value is determined based on whether a BV corresponding to a first node overlaps with BVs corresponding to respective sibling nodes along a path of a ray. Subsequently, if a hit is detected between a ray and the first node, BVs corresponding to sibling nodes that do not overlap with the first node are considered to be obscured by the node, and thus traversal of those sibling nodes is safely omitted. For purposes of simplicity, FIGS. 3-5 refer to BVs as opposed to primitives. However, these examples apply similarly to sets of primitives.

FIG. 3 is a block diagram depicting an example BVH structure 300 that is used to perform a ray tracing operation, such as the ray tracing operations performed in the examples of FIGS. 4 and 5, in accordance with some implementations. In some implementations, BVH structure 300 is BVH tree 107 of FIG. 1. More specifically, BVH structure 300 depicts a four wide BVH. In BVH structure 300, nodes 302, 304, 306, and 308 occupy a first level. Nodes 312, 314, 316, and 318 are children of (correspond to BVs that are contained within a BV corresponding to) node 302. Nodes 322, 324, 326, and 328 are children of node 304 and occupy a second level. Nodes 332, 334, 336, and 338 are children of node 306 and also occupy the second level. Nodes 342, 344, 346, and 348 are children of node 308 and also occupy the second level. Nodes 352, 354, 356, and 358 are children of node 322 and occupy a third level. Nodes 362, 364, 366, and 368 are children of node 324 and also occupy the third level. nodes 372, 374, 376, and 378 are children of node 326 and also occupy the third level. Nodes 382, 384, 386, and 388 are children of node 328 and also occupy the third level. In the illustrated example, other nodes in the second level also have children. Further, in some implementations, nodes in the third level have children and so forth. In some implementations, not every node has children (BVH structure 300 is not fully symmetrical). Nodes without children correspond to primitives rather than BVs.

FIG. 4 is a block diagram depicting an example 400 set of BVs corresponding to nodes that are traversed as part of a ray tracing operation in accordance with some implementations. In example 400, ray 402 hits each of BVs 422, 424, 426, and 428, which correspond to nodes 322, 324, 326, and 328, respectively. As illustrated in FIG. 3, nodes 322, 324, 326, and 328 are sibling nodes. Example 400 also depicts BVH stack 404, which, in some implementations, corresponds to BVH stack 116 of FIG. 1. In example 400, BVH stack 404 is generated as a result of detecting a hit with BV 424, and thus many of the values in BVH stack 404 are generated based on properties of BV 424 (e.g., whether a given BV overlaps with BV 424). In other words, BV 424 and corresponding node 324 are considered to be “under consideration.” In example 400, a hit is also detected with a BV which corresponds to node 362, a child node of node 324. BVH stack 404 further includes a parent overlap value that indicates whether a BV corresponding to a parent node of the node under consideration overlaps with any BVs corresponding to sibling nodes of the parent node. In such a case, even if a primitive within the BV of the node under consideration is detected as a hit, it is possible that another primitive (e.g., a primitive within a BV corresponding to a cousin node) is an earlier hit due to the overlap. In example 400, a BV corresponding to node 304, which is a parent of each of nodes 322, 324, 326, and 328, does not overlap with BVs corresponding to any of its sibling nodes, nodes 302, 306, or 308, for ease of explanation. In some implementations, the parent overlap value is included in the corresponding discard value. In some implementations, a single value is stored to represent parent overlap values for multiple nodes (e.g., a single value represents the parent overlap values for nodes 322, 326, and 328). Further, in some implementations, a number of siblings per level is stored.

Additionally, in some implementations, an overlap stack pointer is set that indicates a location at which to start checking for the discard value. The overlap stack pointer is set to equal a current stack pointer, indicating a current node, when a ray hits a primitive. Discard values are only checked when removing or culling stack elements corresponding to nodes having stack positions below the position indicated by overlap stack pointer within a corresponding BVH structure (e.g., BVH structure 300). As a result, omitting traversal of a node is performed in response to determining that the node corresponds to a position below the position indicated by the overlap stack pointer. If an overlap is found, then the overlap stack pointer is reset to the current stack pointer and traversal continues proceeding down BVH structure 300. For example, if a primitive within BV 424 is identified as a hit, the overlap stack pointer is set to a stack pointer, which is currently 3. As a result, when the entry corresponding to node 362 is culled from or popped off BVH stack 404, its discard value is checked. Because the entry corresponding to node 362 has a discard value that indicates “keep,” the entry corresponding to node 362 is culled from or popped off BVH stack 404 and the stack pointer and overlap stack pointer are reset to 2. Then the tree through node 362 continues to be traversed. If another hit is identified, then the overlap stack pointer is again reset to the stack pointer.

Discard values are determined for a node based on whether the BV corresponding to the node overlaps with BVs corresponding to sibling nodes. Although the discard values in BVH stack 404 are illustrated separately for clarity, in some implementations, the discard values for node 324 relative to the sibling nodes 322, 326, and 328 are stored together as a single discard value (e.g., 011 representing discard, keep, keep). In other implementations, the discard values are stored separately. In example 400, because BV 424 does not overlap with BV 428, the corresponding discard value indicates that node 328 is safe to discard if BV 424 is identified as an earlier hit along a path of a ray.

As described above with reference to FIG. 1, in some cases, discard values are calculated prior to performing intersection operations between the ray and the BVs and primitives. In such a case, because BV 424 overlaps with BVs 422 and 426, discard values indicate that nodes 322 and 326 are to be kept and subsequently traversed in case a ray hits one of BVs 422 or 426 prior to BV 424.

In some implementations, if the discard values are used to omit traversal of nodes, processing resources are saved as compared to a system that traverses every node corresponding to a detected potential hit. Further, in some cases, storing discard values uses less storage space, as compared to storing a collision distance between an origin of a ray and each BV, primitive, or both.

FIG. 5 is a block diagram depicting an example 500 set of BVs corresponding to nodes that are traversed as part of a ray tracing operation in accordance with some implementations. In example 500, ray 502 hits each of BVs 522, 524, 526, and 528, which correspond to nodes 322, 324, 326, and 328, respectively. As illustrated in FIG. 3, nodes 322, 324, 326, and 328 are sibling nodes. Example 500 also depicts BVH stack 504, which, in some implementations, corresponds to BVH stack 116 of FIG. 1. In example 500, BVH stack 504 is generated as a result of detecting a hit with BV 524, and thus many of the values in BVH stack 504 are generated based on properties of BV 524 (e.g., whether a given BV overlaps with BV 524). In other words, BV 524 and corresponding node 324 are considered to be “under consideration.” In example 500, a hit is also detected with a BV which corresponds to node 362, a child node of node 324. BVH stack 504 further includes a parent overlap value that indicates whether a BV corresponding to a parent node of the node under consideration overlaps with any BVs corresponding to sibling nodes of the parent node. In such a case, even if a primitive within the BV of the node under consideration is detected as a hit, it is possible that another primitive (e.g., a primitive within a BV corresponding to a cousin node) is an earlier hit due to the overlap. In example 500, a BV corresponding to node 304, which is a parent of each of nodes 322, 324, 326, and 328, does not overlap with BVs corresponding to any of its sibling nodes, nodes 302, 306, or 308, for ease of explanation. In some implementations, the parent overlap value is included in the corresponding discard value. In some implementations, a single value is stored to represent parent overlap values for multiple nodes (e.g., a single value represents the parent overlap values for nodes 322, 326, and 328). Further, in some implementations, a number of siblings per level is stored.

Additionally, in some implementations, an overlap stack pointer is set that indicates a location at which to start checking for the discard value. The overlap stack pointer is set to equal a current stack pointer, indicating a current node, when a ray hits a primitive. Discard values are only checked when removing or culling stack elements corresponding to nodes having stack positions below the position indicated by overlap stack pointer within a corresponding BVH structure (e.g., BVH structure 300). As a result, omitting traversal of a node is performed in response to determining that the node corresponds to a position below the position indicated by the overlap stack pointer. If an overlap is found, then the overlap stack pointer is reset to the current stack pointer and traversal continues proceeding down BVH structure 300. For example, if a primitive within BV 524 is identified as a hit, the overlap stack pointer is set to a stack pointer, which is currently 3. As a result, when the entry corresponding to node 362 is culled from or popped off BVH stack 504, its discard value is checked. Because the entry corresponding to node 362 has a discard value that indicates “keep,” the entry corresponding to node 362 is culled from or popped off BVH stack 504 and the stack pointer and overlap stack pointer are reset to 2. Then the tree through node 362 continues to be traversed. If another hit is identified, then the overlap stack pointer is again reset to the stack pointer.

Discard values are determined for a node based on whether the BV corresponding to the node overlaps with BVs corresponding to sibling nodes. Although the discard values in BVH stack 504 are illustrated separately for clarity, in some implementations, the discard values for node 324 relative to the sibling nodes 322, 326, and 328 are stored together as a single discard value (e.g., 011 representing discard, keep, keep). In other implementations, the discard values are stored separately. In example 500, because BV 524 does not overlap with BV 528, the corresponding discard value indicates that node 328 is safe to discard if BV 524 is identified as an earlier hit along a path of a ray.

As described above with reference to FIG. 1, in some cases, discard values are calculated subsequent to performing intersection operations between the ray and the BVs and primitives. In such a case, a path of ray 502 is known. As a result, the overlap between BVs 522 and 524 is not relevant because the intersection between the path of the ray and BV 522 is outside of the overlap between BVs 522 and 524. Thus, a discard value would indicate that node 322 is safe to discard. In contrast, the overlap between BVs 524 and 526 occurs along the path of ray 502. Therefore, it is possible ray 502 intersects with an object within BV 526 prior to with an object within BV 524. As a result, a corresponding discard value indicates that node 326 is to be kept.

In some implementations, if the discard values are used to omit traversal of nodes, processing resources are saved as compared to a system that traverses every node in which a potential hit is detected. Further, in some cases, storing discard values uses less storage space, as compared to storing a collision distance between an origin of a ray and each BV, primitive, or both.

FIG. 6 is a flow diagram illustrating a method 600 of generating a stream of frames by traversing a stack corresponding to a BVH structure in accordance with some implementations. In some implementations, various portions are performed in another order. For example, in some implementations, block 604 is performed subsequent to block 602 but prior to block 610. In some implementations, method 600 is initiated by one or more processors in response to one or more instructions stored by a computer readable storage medium. Although method 600 is described in terms of BVs, in other implementations, method 600 uses primitives instead of BVs.

At block 602, a BVH structure for a scene is generated. For example, BVH tree 107 of FIG. 1 is generated. At block 604, as part of generating the BVH structure, a plurality of discard values are generated that indicate whether BVs corresponding to nodes overlap with BVs corresponding to sibling nodes. For example, as part of generating BVH tree 107, discard values 109 are generated.

At block 610, a stream of frames is generated by traversing the BVH structure. For example, a stream of frames is generated by traversing BVH tree 107. At block 612, as part of traversing the BVH structure, a hit along a path of a ray is detected. For example, intersection engine 114 detects a hit with a BV 424 of FIG. 4 along a path of a ray.

At block 614, as part of traversing the BVH structure, a determination is made whether a corresponding discard value indicates an overlap with a BV corresponding to a sibling node. If an overlap is not indicated, traversal of the sibling node is omitted at block 616. If an overlap is indicated, the sibling node is traversed at block 618. For example, if a discard value indicates no overlap between BV 424 and BV 428, then traversal of node 328 is omitted. As another example, if a discard value indicates an overlap between BV 424 and BV 422, then traversal of node 322 is performed. Accordingly, a method of generating a stream of frames by traversing a stack corresponding to a BVH structure is depicted.

FIG. 7 is a flow diagram illustrating a method 700 of generating a stream of frames by traversing a stack corresponding to a BVH structure in accordance with some implementations. In some implementations, various portions are performed in another order. For example, in some implementations, block 714 is performed prior to block 712 (e.g., after the path of the ray is determined but prior to an intersection being detected). In some implementations, method 700 is initiated by one or more processors in response to one or more instructions stored by a computer readable storage medium. Although method 700 is described in terms of BVs, in other implementations, method 700 uses primitives instead of BVs.

At block 702, a BVH structure for a scene is generated. For example, BVH tree 107 of FIG. 1 is generated. At block 710, a stream of frames is generated by traversing the BVH structure. For example, a stream of frames is generated by traversing BVH tree 107.

At block 712, as part of traversing the BVH structure, a hit along a path of a ray is detected. For example, intersection engine 114 detects a hit with a BV 524 of FIG. 5 along a path of a ray. At block 714, as part of traversing the BVH structure, a plurality of discard values are generated that indicate whether BVs corresponding to nodes overlap with BVs corresponding to sibling nodes along the path of the ray. For example, as part of generating BVH tree 107, discard values 109 are generated.

At block 716, as part of traversing the BVH structure, a determination is made whether a corresponding discard value indicates an overlap with a BV corresponding to a sibling node along the path of the ray. If an overlap along the path of the ray is not indicated, traversal of the sibling node is omitted at block 718. If an overlap along the path of the ray is indicated, the sibling node is traversed at block 720. For example, if a discard value indicates no overlap along the path of ray 502 of FIG. 5 between BV 524 and BV 522, then traversal of node 322 is omitted. As another example, if a discard value indicates an overlap along the path of ray 502 between BV 524 and BV 526, then traversal of node 326 is performed. Accordingly, a method of generating a stream of frames by traversing a stack corresponding to a BVH structure is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations. “Circuitry” and “circuit” are used throughout this disclosure interchangeably.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A processing system, comprising:
a memory circuit configured to store a bounding volume hierarchy (BVH) structure that comprises ray tracing context data; and
a processing circuit configured to:
generate the BVH structure comprising generating a plurality of nodes; and
generate a stream of frames by traversing the BVH structure, comprising:
in response to detecting that a ray intersects with a first bounding volume (BV) or primitive corresponding to a first node of the BVH structure, checking a first discard value generated based on overlaps between the first BV or primitive and at least one BV or primitive corresponding to at least one sibling node; and
in response to the first discard value indicating that the at least one sibling node is to be discarded, omitting traversal of the at least one sibling node.

2. The processing system of claim 1, wherein traversing the BVH structure further comprises:
in response to the first discard value indicating that a second node is not to be discarded, traversing the second node.

3. The processing system of claim 2, wherein the processing circuit is further configured to:
generate a plurality of discard values corresponding to respective nodes of the plurality of nodes and including the first discard value.

4. The processing system of claim 3, wherein generating the BVH structure further comprises:
generating the plurality of discard values.

5. The processing system of claim 4, wherein generating the first discard value further comprises:
setting the first discard value to indicate whether the first BV or primitive overlaps with any of the at least one BV or primitive corresponding to the at least one sibling node.

6. The processing system of claim 3, wherein traversing the BVH structure further comprises:
generating the plurality of discard values.

7. The processing system of claim 6, wherein generating the first discard value further comprises:
setting the first discard value to indicate whether the first BV or primitive overlaps with any of the at least one BV or primitive corresponding to the at least one sibling node along a path of the ray.

8. The processing system of claim 1, wherein traversing the BVH structure further comprises:
generating a BVH stack of entries corresponding to respective nodes of the plurality of nodes and corresponding BVs or primitives to check for a closest hit for the ray; and
managing a first entry of the BVH stack, wherein the first entry corresponds to the first node and the first BV or primitive and comprises the first discard value.

9. The processing system of claim 8, wherein omitting the traversal of the at least one sibling node for the ray further comprises:
culling at least one entry of the BVH stack corresponding to the at least one sibling node.

10. The processing system of claim 8, wherein the first entry further comprises:
an indication of a number of nodes that are pushed onto the BVH stack per level of the BVH structure; and
a parent overlap value that indicates whether a BV corresponding to a parent node of the first node overlaps with any BVs corresponding to sibling nodes of the parent node.

11. A method, comprising:
generating a bounding volume hierarchy (BVH) structure that comprises ray tracing context data;
generating a discard value that indicates whether a first bounding volume (BV) or primitive corresponding to a first node of the BVH structure overlaps with any BVs or primitives corresponding to at least one sibling node; and
generating a stream of frames by traversing the BVH structure, comprising:
in response to detecting that a ray intersects with the first BV or primitive, checking the discard value; and
in response to the discard value indicating that the at least one sibling node is to be discarded, omitting traversal of the at least one sibling node.

12. The method of claim 11, wherein traversing the BVH structure further comprises:
in response to the discard value indicating that a second node is not to be discarded, traversing the second node, wherein a second BV or primitive corresponding to the second node overlaps with the first BV or primitive.

13. The method of claim 12, wherein the second BV or primitive overlaps with the first BV or primitive at a location outside of a path of the ray.

14. The method of claim 11, wherein the discard value further comprises a parent overlap value that indicates whether a BV corresponding to a parent node of the first node overlaps with any BVs corresponding to sibling nodes of the parent node.

15. The method of claim 11, wherein omitting the traversal of the at least one sibling node for the ray further comprises:
culling at least one entry of a BVH stack corresponding to the at least one sibling node.

16. A method, comprising:
generating a bounding volume hierarchy (BVH) structure that comprises ray tracing context data; and
generating a stream of frames by traversing the BVH structure, comprising:
in response to detecting that a ray intersects with a first bounding volume (BV) or primitive corresponding to a first node of the BVH structure, generating a discard value based on whether the first BV or primitive overlaps with any BVs or primitives corresponding to at least one sibling node along a path of the ray; and
in response to the discard value indicating that the at least one sibling node is to be discarded, omitting traversal of the at least one sibling node.

17. The method of claim 16, wherein traversing the BVH structure further comprises:
in response to the discard value indicating that a second node is not to be discarded, traversing the second node, wherein a second BV or primitive corresponding to the second node overlaps with the first BV or primitive along the path of the ray.

18. The method of claim 17, wherein generating the discard value further comprises:
setting an overlap stack pointer to a current stack pointer of a BVH stack corresponding to the BVH structure in response to identifying that the second BV or primitive overlaps with the first BV or primitive along the path of the ray.

19. The method of claim 18, wherein omitting the traversal of the at least one sibling node is performed in response to determining that all of the at least one sibling node corresponds to stack positions in the BVH stack below a stack position referred to by the overlap stack pointer.

20. The method of claim 16, wherein at least one BV or primitive corresponding to the at least one sibling node overlaps with the first BV or primitive outside of the path of the ray.
